(19) United States
(12) Patent Application Publication
(10) Pub. No.: US 2008/0019870 A1
(43) Pub. Date: Jan. 24, 2008

(54) Integrated medical device dispensing and lancing mechanisms and methods of use

(76) Inventors: Michael John Newman, Ware (GB); Thomas Paul Henley, Biggleswade (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/490,600

(22) Filed: Jul. 21, 2006

(51) Int. Cl. G01N 35/00

(52) U.S. Cl. 422/68.1; 422/63

(57) ABSTRACT

Metering systems for measuring the concentration of an analyte in a fluid sample are provided. More particularly, transport mechanisms for use with such metering systems for moving a test sensor or the like between various operating positions of a metering system such as a storage position and a test position are described.

### TECHNICAL FIELD

The present invention relates generally to metering systems for measuring the concentration of an analyte in a fluid sample. More particularly, the present invention relates to transport mechanisms for use with such metering systems for moving a test sensor or the like between various operating positions of a metering system such as a storage position and a test position.

### BACKGROUND

Metering systems for measuring an analyte or indicator (e.g., glucose, HbAlc, lactate, cholesterol) in a fluid such as a body fluid (e.g., blood, interstitial fluid, urine) typically make use of disposable test sensors, which sometimes include integral lancets. A test sensor that is specific for the analyte or indicator of interest is inserted into the metering system, within which it becomes physically and electrically connected with a measuring circuit of the metering system. Thus, following application of a sample to the test sensor, a measurement result is obtained providing an indication of the quantity of the analyte or indicator within the sample.

The insertion of a test sensor into a metering system is often a manual operation in which a user of the metering system must transfer a test sensor from a vial or storage container into a connector port of the metering system. The vial in which test sensors are stored provides a controlled atmosphere that is required to preserve the viability of the test sensor. A user of the metering system is therefore required to open the vial, remove a test sensor, and reseal the vial every time a measurement is made. This process can be both time-consuming and cumbersome, depending on the type of vials and metering systems used and may result in poor testing procedures and/or inaccurate test results.

An improvement to these metering systems described above involves using a removable and replaceable cassette or cartridge of test sensors within the metering system. With this improvement, the user is not required to manually transfer a test sensor from a vial to a connector prior to making a measurement. A test sensor is instead transferred directly from the cartridge into a test position using some type of manually activated system. This type of system can position a portion of the test sensor, such as a sample receiving area or a lancet, outside the meter casing for making a measurement.

Metering systems using cartridges or other test sensor storage components are typically somewhat larger than systems that are designed for manual insertion of a single test sensor at a time. This increased size of the metering systems with cartridges is due to both the size of the cartridge and the size of the mechanisms used within the device for moving a test sensor from the cartridge to the test position, such as motors, conveyors, and the like. In order to minimize the size of these metering systems, it is common for the strips to be provided in a certain orientation and moved in the same general orientation to the test position. While this movement and orientation of each strip can be acceptable in many circumstances, it may be more convenient in some circumstances to provide a metering system that is capable of reorienting the test sensors between their position in the cartridge and their test position.

### SUMMARY

The present invention thus provides transport mechanisms, for metering systems, that can dispense a test sensor or strip, with or without an integral lancet, from an internal cassette or cartridge of the metering system in an orientation different from a storage orientation of the test sensor in the cassette or cartridge. Because test sensors need to be kept sterile, at a low relative humidity, and protected from mechanical damage it is advantageous to store a test sensor with a lancet or blood-receiving region of the test sensor facing generally away from the direction in which the test sensor is extracted from a storage cell of a cassette or cartridge. The present invention thus provides mechanisms and techniques for backward extraction of test sensors stored in a cassette or cartridge. That is, test sensors are removed in a blood-receiving region last or lancet last manner.

Accordingly, in an aspect of the present invention, a transport apparatus for use in a metering system is provided. The transport apparatus comprises a frame, first and second arms, a connector, and first and second guiding systems. The first arm is pivotably connected to the frame at a first pivot point. The second arm is pivotably connected to an end of the first arm at a second pivot point. The connector is pivotably connected to an end of the second arm at a third pivot point. The connecter is designed for carrying an integrated medical device or test strip and is capable of being moved between a first location where the connector has a first orientation and a second location where the connector has a second orientation. The first guiding system guides the third pivot point along a linear path and comprises a linear guide surface operatively integrated with the frame and a guide surface positioned at the end of the second arm. The second guiding system changes the orientation of the connector between the first orientation and the second orientation as the third pivot point moves along the linear axis and comprises a first cam surface operatively integrated with the frame and a second cam surface operatively integrated with the connector.

In another aspect of the present invention, a method for moving a connector between a first location where the connector has a first orientation and a second location where the connector has a second orientation in a metering system is provided. The method comprises the steps of: providing a transport apparatus comprising a frame, a first arm pivotably connected to the frame at a first pivot point, a second arm pivotably connected to an end of the first arm at a second pivot point, and a connecter pivotably connected to an end of the second arm at a third pivot point; causing the first arm to rotate about the first pivot point and the second arm to rotate about the second pivot point; translating the third pivot point along a linear path; and rotating the connector about the third pivot point between a first orientation and a second orientation while the third pivot point is translated along the linear path.

### BRIEF DESCRIPTION OF THE DRAWINGS

These and other features, aspects, and advantages of the present invention will become better understood with regard to the following description, appended claims, and accompanying drawings where:

FIG. 1 is a perspective view of an exemplary transport mechanism in accordance with the present invention;

FIG. 2 is perspective view of an exemplary test sensor that can be transported by a transport mechanism in accordance with the present invention;

FIG. 3 is a perspective view of a cartridge that can position a source of test sensors relative a transport mechanism in a metering system in accordance with the present invention;

FIG. 4 is a perspective view of a metering system including the transport mechanism of FIG. 1 and cartridge of FIG. 3 in accordance with the present invention;

FIG. 5 is a perspective view of the transport mechanism of FIG. 1 shown in a rest position in accordance with the present invention;

FIG. 6 is a top view of the transport mechanism of FIG. 1 in accordance with the present invention;

FIG. 7 is a perspective, partial cut away view of a metering system including another exemplary transport mechanism in accordance with the present invention;

FIG. 8 is a flow chart illustrating a process for extracting a test sensor from a chamber of a cartridge and lancing a dermal tissue target site using a transport mechanism in accordance with the present invention;

FIGS. 9-19 are sequential schematic perspective views of a dispensing and lancing operation using the metering system of FIG. 4 in accordance with an aspect of the present invention; and

FIGS. 20-33 are sequential schematic perspective views of a dispensing and lancing operation using the metering system of FIG. 7 in accordance with another aspect of the present invention

FIG. 34 is a simplified bottom view of a portion of another exemplary transport mechanism in accordance with the present invention.

### DETAILED DESCRIPTION

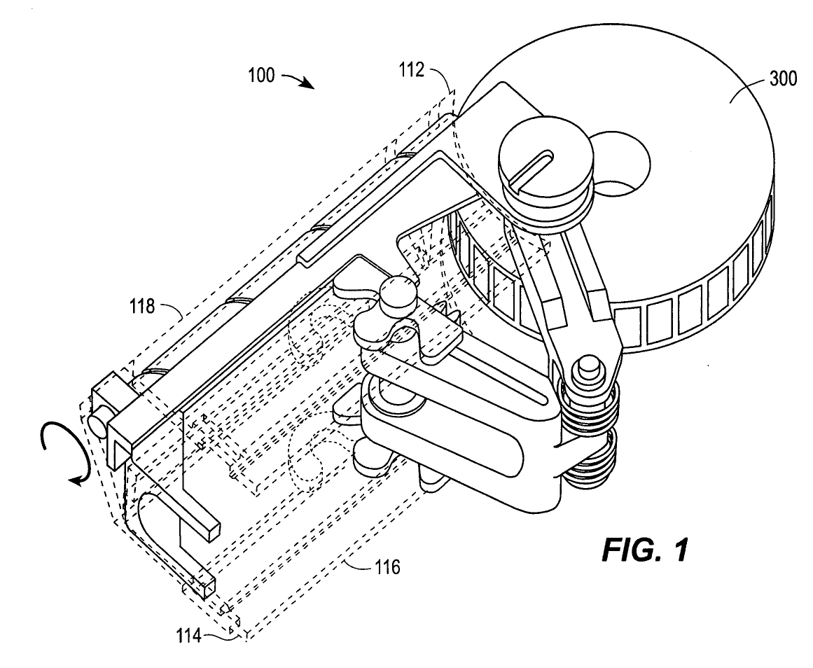

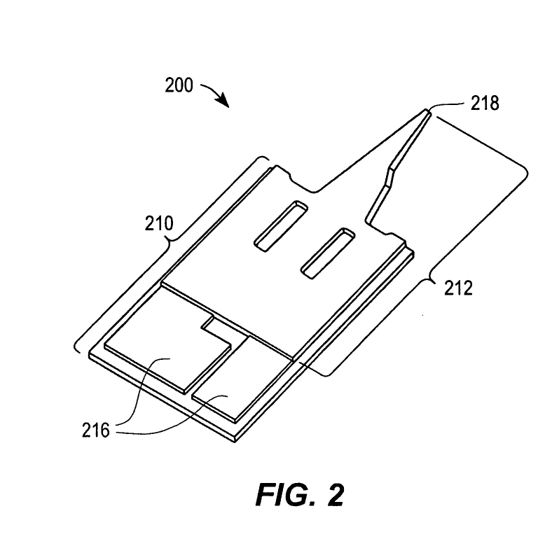

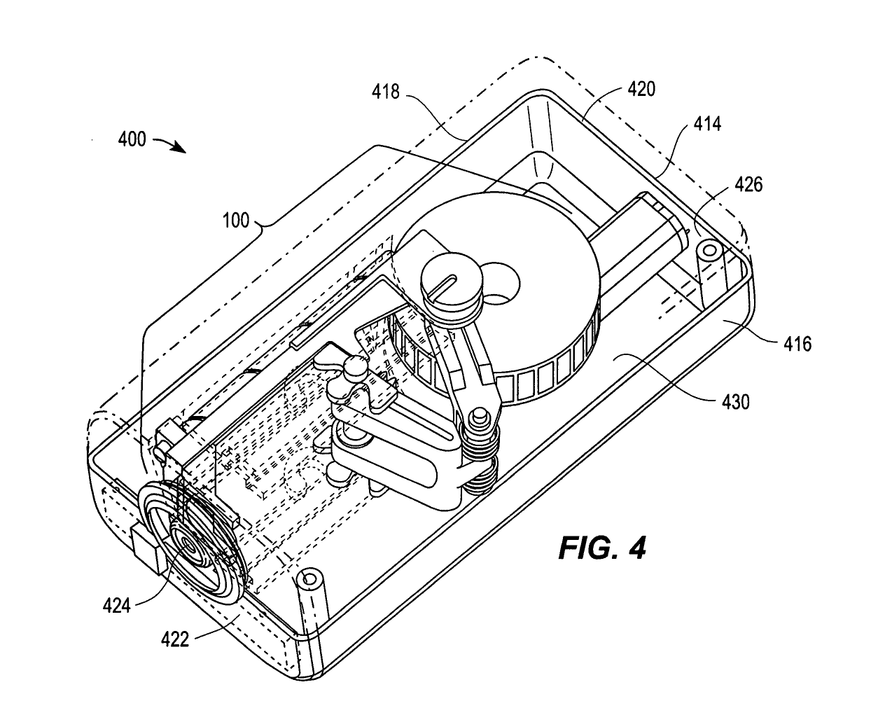

FIG. 1 is a perspective view of an exemplary dispensing and lancing mechanism 100 or transport mechanism for a test sensor such as the integrated medical device 200 shown in FIG. 2 in accordance with the present invention. Dispensing and lancing mechanism 100 includes a distal end 112, a proximal end 114, a first longitudinal side 116, and a second longitudinal side 118. Dispensing and lancing mechanism 100 is designed to automatically and controllably move integrated medical devices 200 individually from a storage location of cartridge 300 to a sample delivery port 424 in a metering system 400 (see FIG. 4) so that a dermal tissue target site can be lanced.

Referring to FIG. 2, exemplary integrated medical device 200 includes a test strip 210 and a dermal tissue penetration member 212 (e.g., a lancet or micro-needle). Test strip 210 includes a reaction area (not shown) and electrical contacts 216. Dermal tissue penetration member 212 includes a lancet 218 adapted to pierce skin and draw blood into the reaction area of the test strip 210. Examples of integrated medical devices are described in International Application No. PCT/GB01/05634 (published as WO 02/49507 on Jun. 27, 2002) and U.S. patent application Ser. No. 10/143,399 to Yuzhakov et al., filed on May 9, 2002 and entitled “Physiological Sample Collection Devices and Methods of Using the Same” both of which are fully incorporated herein by reference for all purposes.

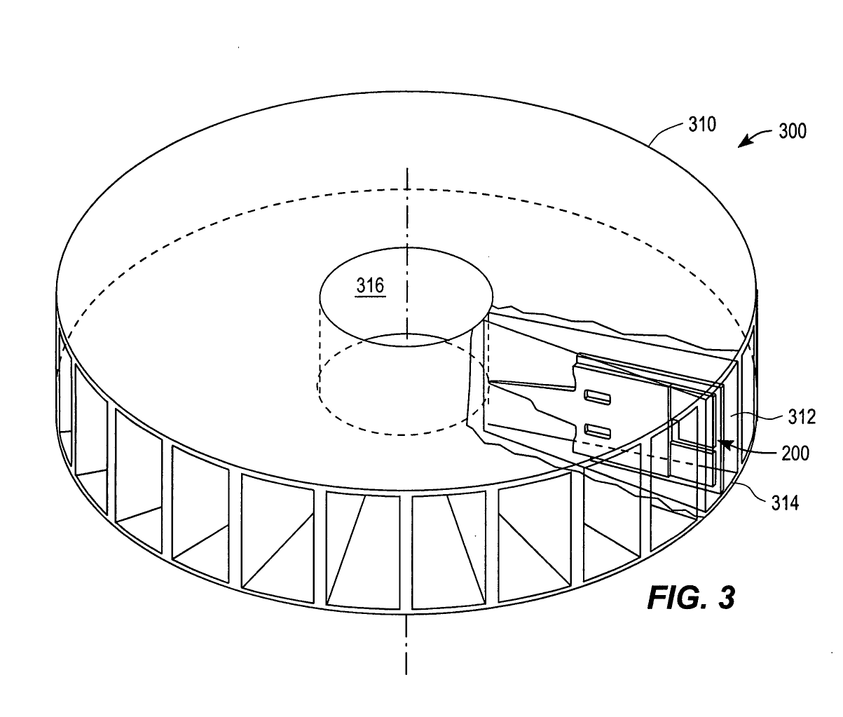

Referring to FIG. 3, integrated medical device 200 is shown as removably retained within a cell of chamber cartridge 300. Cartridge 300 is cylindrical in shape and includes a body 310, a plurality of radially spaced chambers 312 for individually storing integrated medical devices 200 in an ‘on edge’ orientation, an opening 314 for each chamber 312, and an aperture 316 through which a retaining mechanism, e.g., a protrusion (not shown) on the inner surface 426 of metering system 400 (see FIG. 4), engages cartridge 300. Each chamber 312 preferably includes a foil seal (not shown) for protection against humidity and contamination. Cartridge 300 is designed to allow placement of individual integrated medical device 200 within a single chamber 312 such that dermal tissue penetration member 212 of integrated medical device 200 is located toward the aperture 316 of cartridge 300 and is protected from damage during storage of integrated medical device 200. An example of cartridge 300 is described in U.S. patent application Ser. No. 11,241,418 to Newman et al., filed on Sep. 30, 2005, entitled “Cassette Assemblies for Testing Devices and Methods,” and having Atty. Docket No. LSI0145/US/2, which is fully incorporated herein by reference for all purposes.

FIG. 4 is a perspective view of a metering system 400 with an upper casing portion shown by a dotted line and with dispensing and lancing mechanism 100 contained therein. External features of metering system 400 includes a lower casing portion 414, a first longitudinal side 416, a second longitudinal side 418, a distal end 420, a proximal end 422, a sample delivery port 424, an inner surface 426 and a user interface (not shown). Lower casing 414 of metering system 400 defines an internal cavity 430 of sufficient size to retain and support dispensing and lancing mechanism 100 therein. Dispensing and lancing mechanism 100 resides within metering system 400 such that distal end 112, proximal end 114, first longitudinal side 116, and second longitudinal side 118 of dispensing and lancing mechanism 100 correspond to distal end 420, proximal end 422, first longitudinal side 416, and second longitudinal side 418 of metering system 400.

Sample delivery port 424 is located on proximal end 422 of metering system 400. User interface (not shown) is preferably located on or within upper casing portion (not shown) of metering system 400, and includes, for example, a plurality of buttons (not shown) and a visual display (not shown) of liquid crystal or other display type to assist a user in the operation of metering system 400. Depressing, for example, a button (not shown) initiates process 800 which is described in more detail below. Metering system 400 is designed to measure an analyte in a sample of body fluid (e.g. blood). Examples of such metering systems are described in the aforementioned U.S. patent application Ser. No. 10/143,399 and U.S. patent application Ser. No. 10/142,443 to McAllister et al., entitled “Minimal Procedure Analyte Test System,” filed on May 9, 2002, and having Atty. Docket No. LSI0114/US, both of which are fully incorporated herein by reference for all purposes. Analytes that may be measured using such a metering system including glucose, for example.

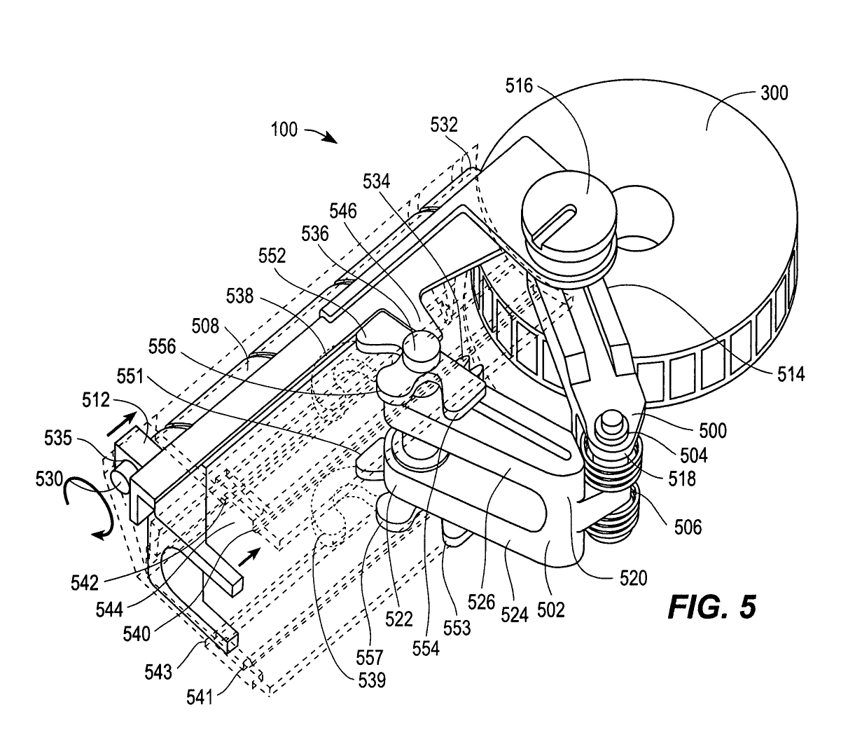

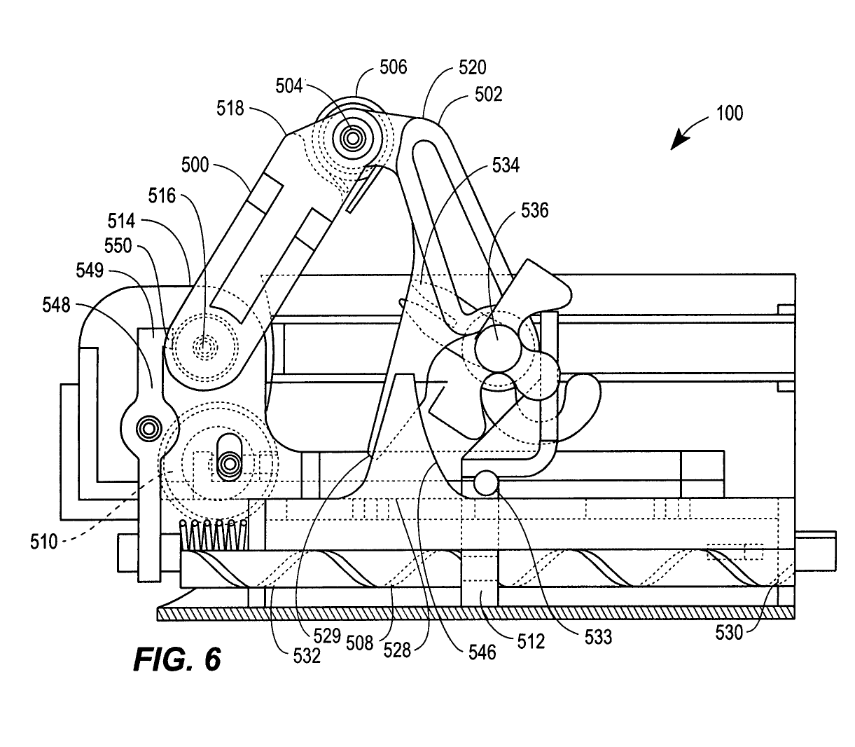

FIGS. 5 and 6 are a perspective view and a top view, respectively, of dispensing and lancing mechanism 100 in a rest position in accordance with the present invention. Dispensing and lancing mechanism 100 is shown in FIG. 6 without cartridge 300. Dispensing and lancing mechanism 100 includes a first lever 500, a second lever 502, a lever pivot 504, a spring 506, a lead screw 508, a motor 510 (see FIG. 6), and a sliding carriage 512. First lever 500 includes a first end 514 attached to a first fixed pivot 516 and a second end 518. Second lever 502 includes a first end 520, a second end 522, a lower arm 524, an upper arm 526, and an extension 528 (see FIG. 6). Extension 528 of second lever 502 includes a proximal end 529 (see FIG. 6). Spring 506 is coiled around lever pivot 504 and provides torsion between first and second levers 500, 502.

Lead screw 508 includes a proximal end 530 and a distal end 532. Distal end 532 of lead screw 508 is attached to a motor 510. Sliding carriage 512 is attached to lead screw 508 and includes an extension contacting feature 533 that functions as a hard stop (see FIG. 6). Rotation of lead screw 508 causes linear movement of sliding carriage 512 along the length of lead screw 508.

Referring to FIG. 5, dispensing and lancing mechanism 100 includes a connector 534, a connector pivot 536, an upper straight rail 540, a lower straight rail 541, an upper cupped rail 542, a lower cupped rail 543, an upper cup 538 within upper cupped rail 542, a lower cup 539 within lower cupped rail 543, a space 544, a positioner 546, a restraining arm 548, a proximal end 549 of restraining arm 548 and a notched linkage 550 (see FIG. 6). Connector 534 is attached to second end 522 of second lever 502 through connector pivot 536. Connector pivot 536 includes a lower first lateral lobe 551, an upper first lateral lobe 552, a lower second lateral lobe 553, an upper second lateral lobe 554, an upper rear lobe 556 and a lower rear lobe 557. Connector 534 movement is restrained within space 544 between upper straight rail 540, lower straight rail 541, upper cupped rail 542, and lower cupped rail 543, so that connector 534 can move linearly and rotate within one plane within space 544. Notched linkage 550 of restraining arm 548 engages a notch in first end 514 of first lever 500 until it is released by movement of carriage 512 as will be described below. Restraining arm 548 is a part of the frame that holds pivot 516. In use, 516 can be adjusted backwards and forwards to change the depth of penetration of the lancet into the skin, for which purpose there is an eccentric adjuster available to the user. There are preferably two fixed pivot points (an upper and lower) and so the adjustment made on one side is transferred to the other side. Restraining arm 548 can be adjusted backwards and forwards (typically about +2 mm) to change the position of the upper and lower fixed pivots.

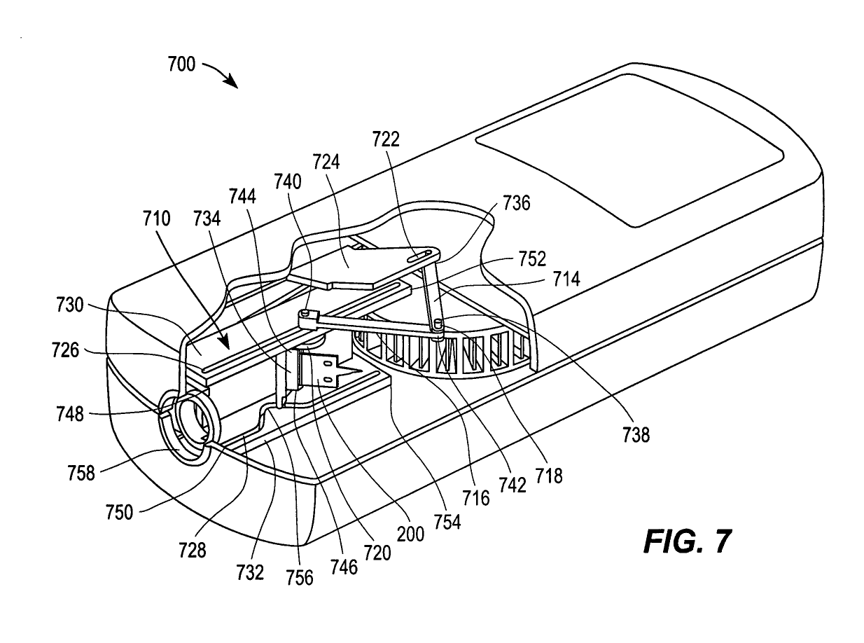

FIG. 7 is a perspective, cut away view of a metering system 700 including a dispensing and lancing mechanism 710 in accordance with the present invention. Dispensing and lancing mechanism 710 includes a motor (not shown), a first lever 714, a second lever 716, a lever pivot 718, a lever pivot spring (not shown), a rotatable cam 720, a slot 722 within a lever holder 724, a first track 726, a second track 728, an upper grooved surface 730, a lower grooved surface 732, and a connector 734. First lever 714 includes a movable end 736 and a pivotable end 738. Second lever 716 includes a first end 740 and a second end 742. Connector 734 includes an upper end 744 and a lower end 746. Upper grooved surface 730 and lower grooved surface 732 includes proximal ends 748, 750 and distal ends 752, 754, respectively. Movement of movable end 736 of first lever 714 toward proximal end 748 within slot 722 of lever holder 724 allows a user to set the depth to which dermal tissue penetration member 212 of integrated medical device 200 will penetrate the dermal tissue target site of the user. Pivotable end 738 of first lever 714 is connected to second end 742 of second lever 716 through pivotable lever pivot 718. First end 740 of second lever 716 is connected via rotatable cam 720 to upper end 744 of connector 734. Second end 742 of second lever 716 pivots around lever pivot 718. Movement of first end 740 of second lever 718 is restrained within first track 726 on upper grooved surface 730. The lever pivot spring (not shown) is coiled around lever pivot 718 and provides torsion between first and second levers 714, 716. Lower end 746 of connector 734 is restrained within second track 728 of lower grooved surface 732. Second track 728 of lower grooved surface 732 includes an indent 756. Indent 756 provides a surface for connector 734 to rotate about 180 degrees when connector 734 moves toward sample delivery port 758. Distal ends 752, 754 of upper and lower grooved surfaces 730, 732 are juxtaposed to sample delivery port 758 on metering system 700 to allow dermal tissue penetration member 212 of integrated medical device 200 to extend out of sample delivery port 758 such that a dermal tissue target site may be lanced as described below.

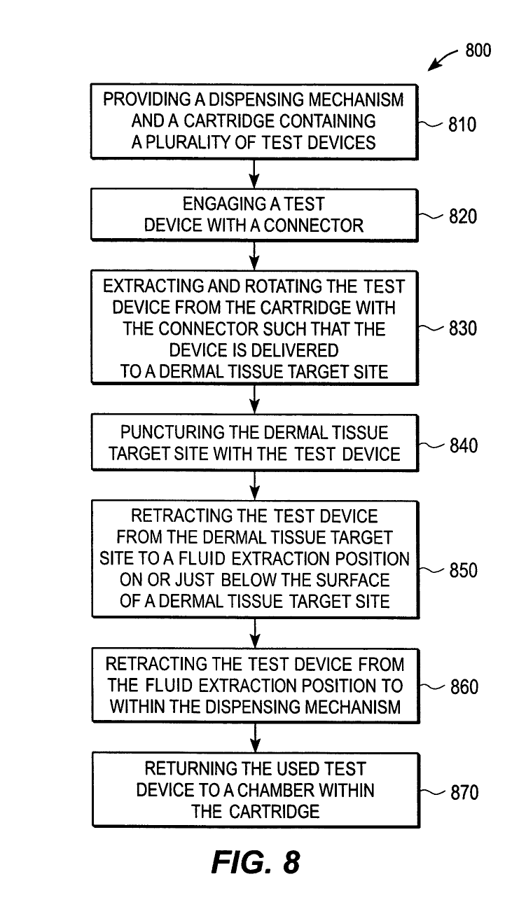

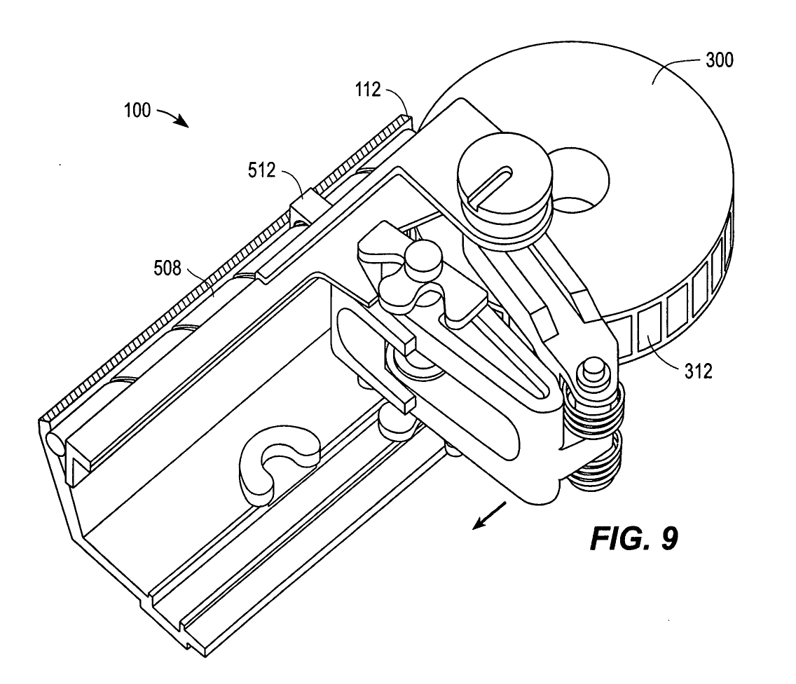

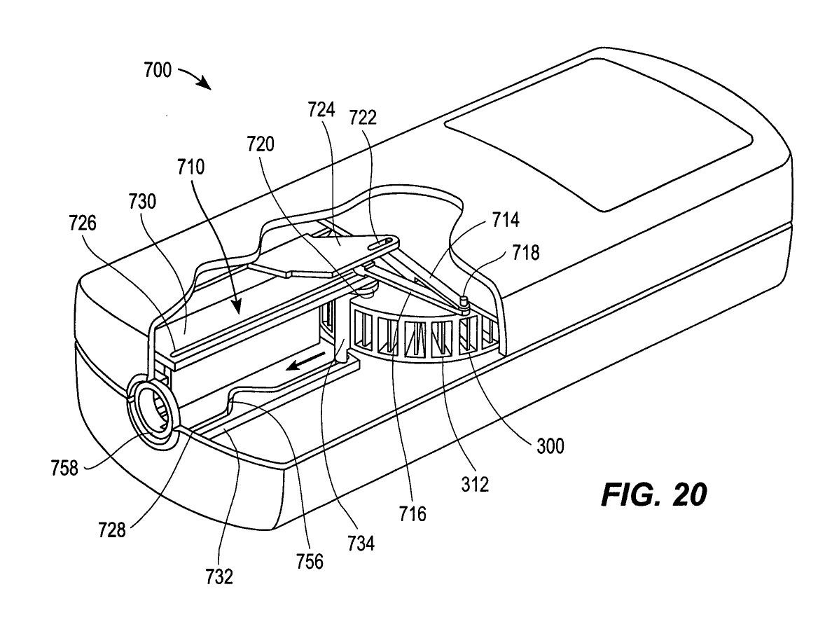

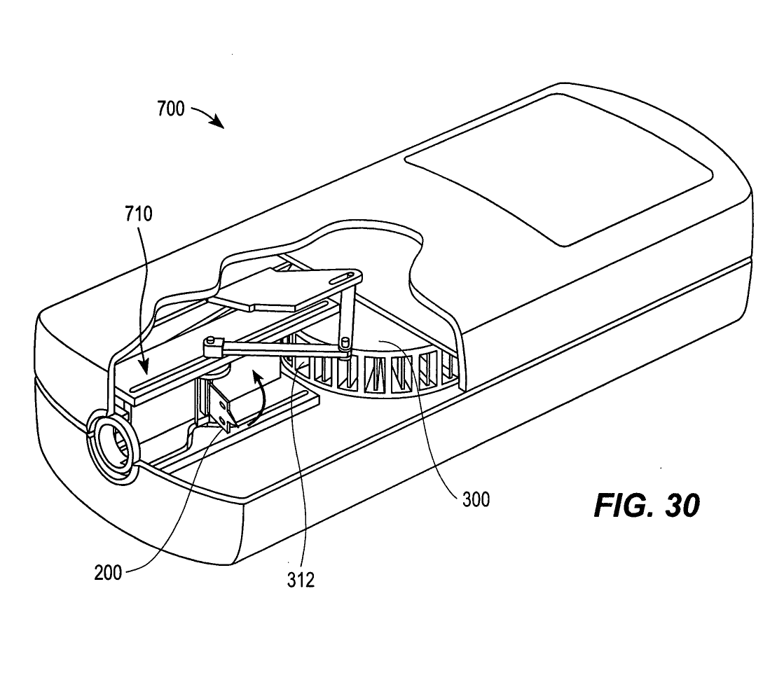

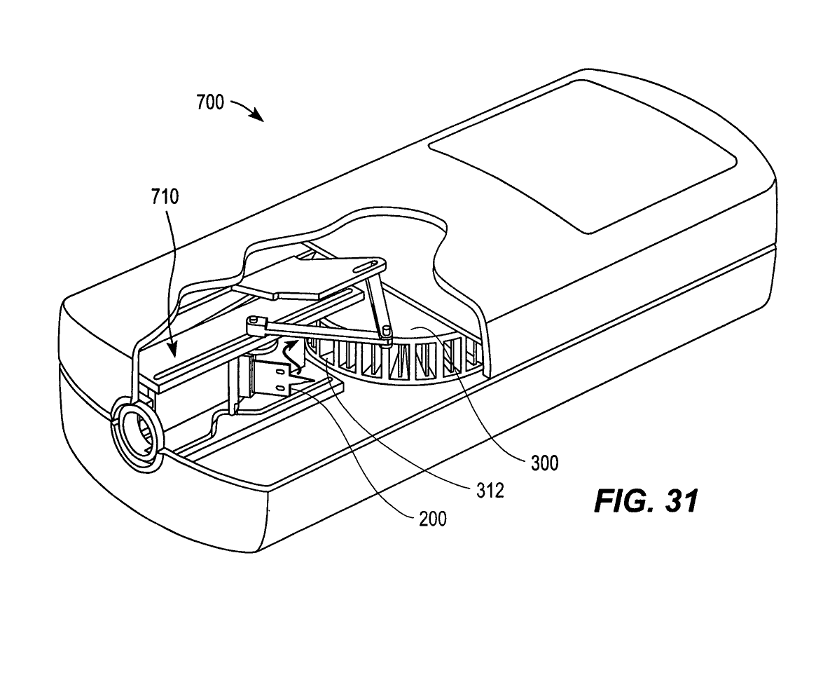

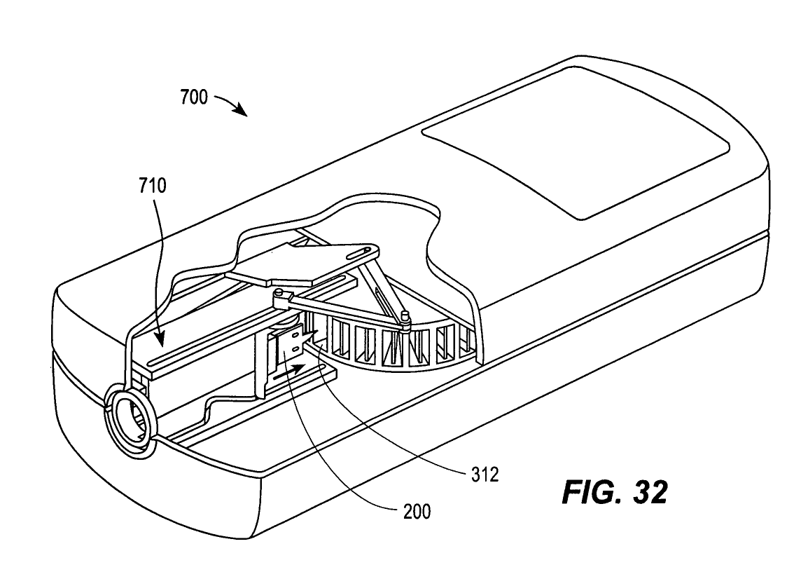

FIG. 8 is a flow chart illustrating a sequence of steps in an exemplary process 800 for extracting an integrated medical device 200 from a chamber 312 of a cartridge 300 and delivering the integrated medical device 200 to a test position of a metering system in accordance with the present invention. Process 800 is described below using FIGS. 9-19 and FIGS. 20-33 (schematic, perspective and top views depicting various stages of process 800). Process 800 will first be described utilizing dispensing and lancing mechanism 100 shown in FIGS. 9-19 and then will be described utilizing dispensing and lancing mechanism 710 shown in FIGS. 20-33.

Process 800 first includes providing a dispensing and lancing mechanism 100 in a rest position with a cartridge 300 containing a plurality of integrated medical devices 200 retained therein, as described above in FIGS. 1 to 6 and as set forth in step 810. The provided dispensing and lancing mechanism 100 is capable of extracting, rotating and delivering an integrated medical device 200 along a machine direction to a sample delivery port 424 of a metering system 400, such that a dermal tissue target site is lanced. During process 800, integrated medical device 200 is rotated while being delivered to sample delivery port 424. The provided dispensing and lancing mechanism 100 includes a first lever 500, a second lever 502, a lever pivot 504, a spring 506, a lead screw 508, a motor 510, and a sliding carriage 512. Dispensing and lancing mechanism 100 further includes a connector 534, a connector pivot 536, an upper cup 538, a lower cup 539, an upper straight rail 540, a lower straight rail 541, an upper cupped rail 542, a lower cupped rail 543 separated by a space 544, and a positioner 546.

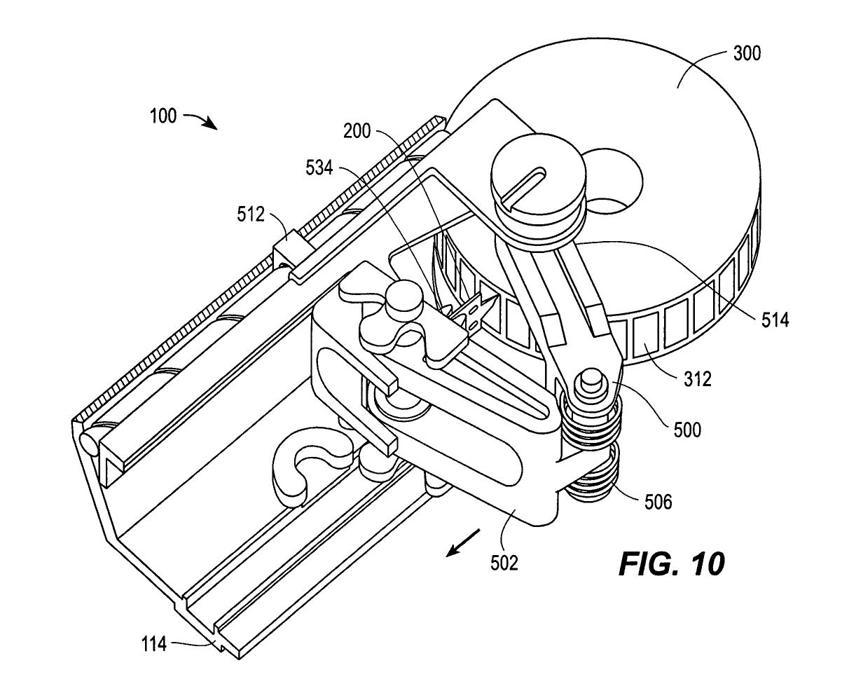

Next, a connector 534 breaches (i.e. ruptures) a foil seal (not shown) and engages an unused integrated medical device 200 (not shown) positioned in a storage location as retained within a chamber 312 of a cartridge 300, as set forth by step 820 and as shown in FIG. 9. To extract an integrated medical device 200 from chamber 312, a moving mechanism (e.g. motor 510 (see FIG. 6), a sliding carriage 512, and a lead screw 508 moves connector 534 linearly toward distal end 112 of dispensing and lancing mechanism 100. Motor 510 rotates lead screw which causes linear movement of sliding carriage 512 toward an individual chamber 312 to engage an integrated medical device 200. Sliding carriage 512 urges connector 534 (see FIG. 10) into chamber 312 and connector 534 engages integrated medical device 200 with a force preferably ranging from about 0.5N to 1.0N, and more preferably about 0.75N.

Connector 534 and engaged integrated medical device 200 are then extracted from chamber 312 and rotated as set forth by step 830 and as illustrated in FIGS. 10-13. Motor 510 reverses direction and sliding carriage 512 moves linearly toward proximal end 114 of dispensing and lancing mechanism 100. Torsion created in spring 506 between first and second levers 500, 502 causes engaged integrated medical device 200 and connector 534 to be removed from chamber 312 of cartridge 300. Movement of connector 534 and engaged integrated medical device 200 is arrested by notched linkage 550 (see FIG. 6) on first end 514 of first lever 500 contacting restraining arm 548 and by sliding carriage 512 preventing movement of first and second levers 500, 502 toward proximal end 114 of dispensing and lancing mechanism 100. Integrated medical device 200 in dispensing and lancing mechanism 100 is now in a “ready-to-fire” position as illustrated in FIG. 10. In the ready-to-fire position the arm 548 is biased in a clockwise direction. At an upper end of arm 548 there is a hook, which engages in a cutout in pivot arm 500, and normally prevents arm 500 from rotating in a clockwise sense. This then holds the mechanism in a cocked or ready to fire position.

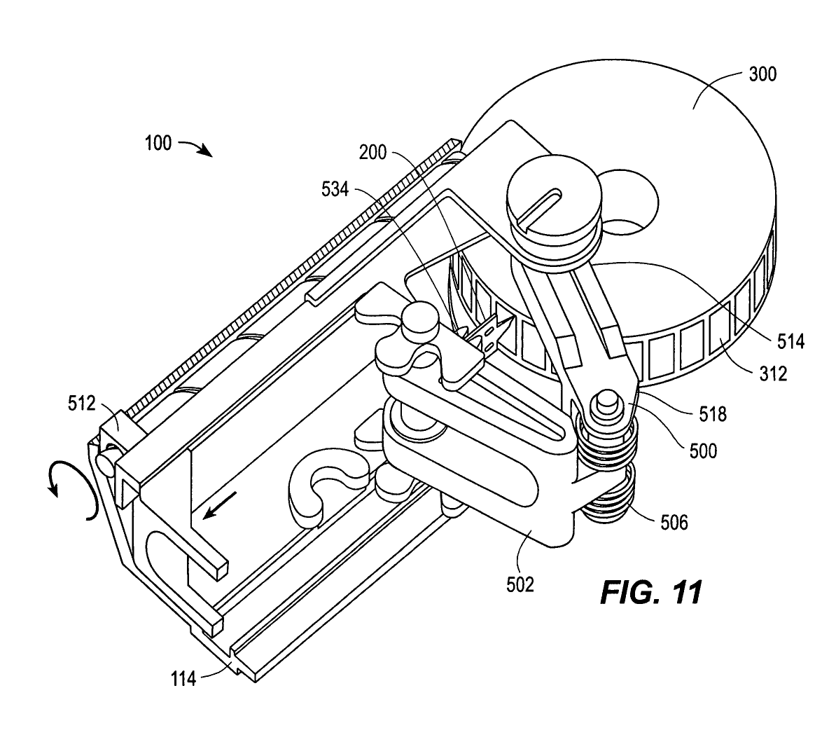

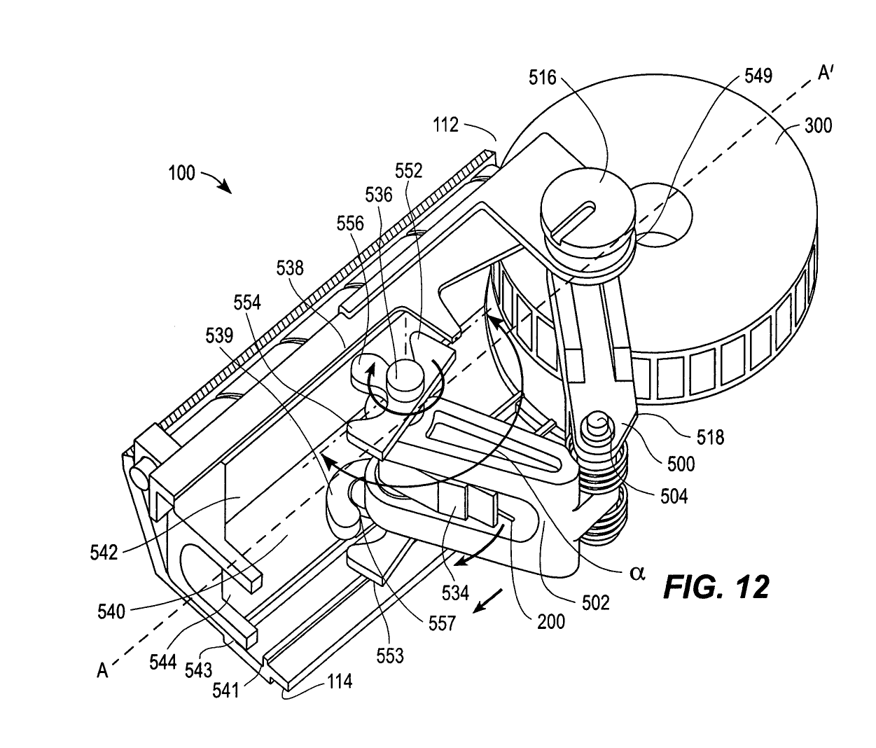

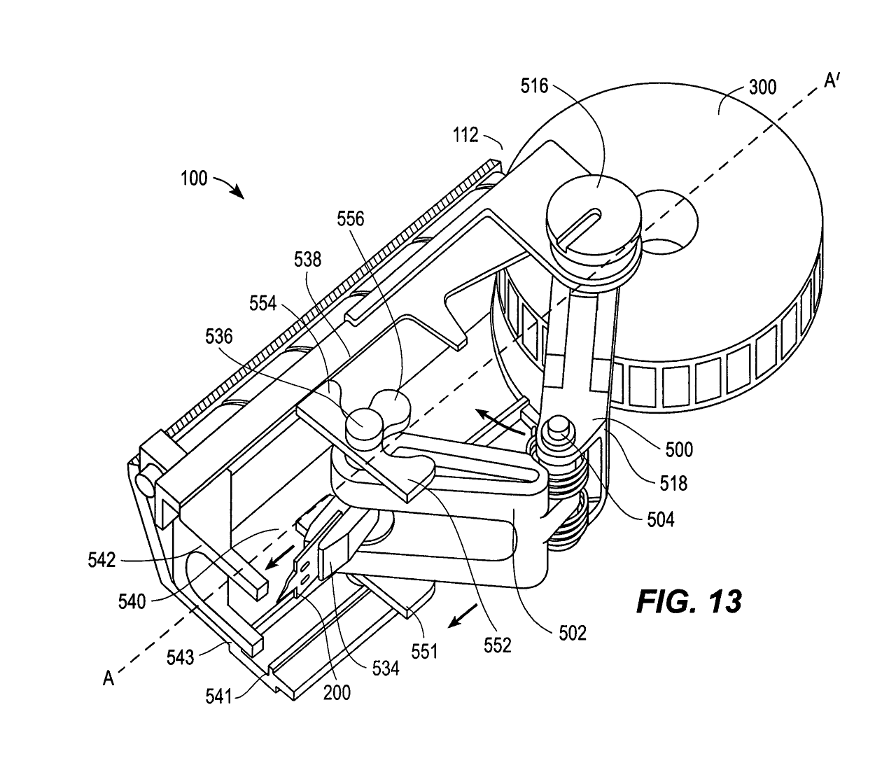

Next, a user places a dermal tissue target site in contact with sample delivery port 424 of metering system 400. A force preferably ranging from 3 to 16 N is applied to the dermal tissue site, preferably for about 5 seconds, to trigger dispensing and lancing mechanism 100 to initiate dermal tissue penetration. Alternatively, dermal tissue penetration may be triggered manually by, for example, depressing a button on metering system 400. When firing of the lancet is triggered, lead screw 508 drives sliding carriage 512 linearly until sliding carriage 512 contacts proximal end 114 of dispensing and lancing mechanism 100 as illustrated in FIG. 11. Movement of carriage 512 causes proximal end 549 of restraining arm 548 to release notched linkage 550 (see FIG. 6), allowing second end 518 of first lever 500 to move laterally toward upper and lower straight rails 540, 541. In this step, a guiding system (i.e. upper and lower cups 538, 539; upper and lower first and second lateral lobes 551, 552, 553, 554 and upper and lower rear lobes 556, 557 of connector 534) rotates the integrated medical device 200 from a “ready-to-fire” position to a test position through an angle α preferably ranging from about 0 degrees to about 180 degrees relative to longitudinal axis A-A′ as illustrated in FIG. 12. Movement of first and second levers 500, 502 causes upper and lower rear lobes 556, 557 of connector 534 to insert into upper and lower cups 538, 539, respectively. Continued movement of first and second levers 500, 502 toward proximal end 114 of dispensing and lancing mechanism 100 causes connector 534 and engaged integrated medical device 200 to rotate clockwise about connector pivot 536 while upper and lower rear lobes 556, 557 of connector 534 remain within upper and lower cups 538, 539, respectively. Upper and lower straight and cupped rails 540, 541, 542, 543 restrain movement of connector 534 to space 544 between upper and lower straight and cupped rails 540, 541, 542, 543 so that as first and second levers 500, 502 are urged toward upper and lower straight rails 540 and 541, connector 534 is urged toward proximal end 114 of dispensing and lancing mechanism 100. As first and second levers 500 and 502 move even closer to proximal end 114 of dispensing and lancing mechanism 100, upper and lower second lateral lobes 553, 554 of connector 534 are urged toward upper and lower cupped rails 542, 543 and upper and lower rear lobes 556, 557 of connector 534 are urged out of upper and lower cups 538, 539, as illustrated by FIG. 13.

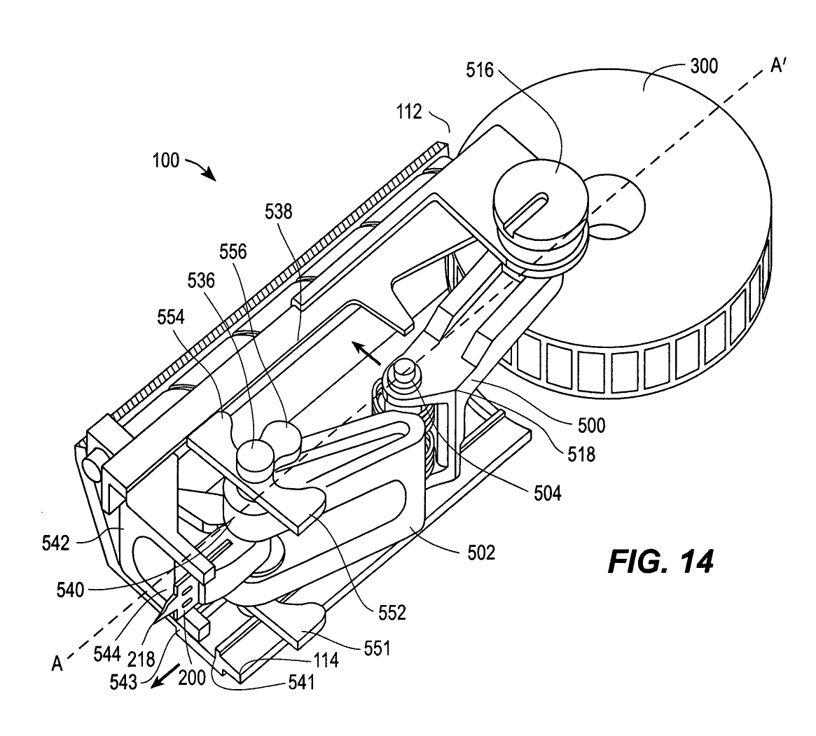

Next, a dermal tissue target site on a user is punctured by integrated medical device 200 as set forth by step 840 and as illustrated in FIG. 14. First and second levers 500, 502 are in a maximally extended position (i.e., first pivot 516, lever pivot 504 and connector pivot 536 are all in line with each other) when lever pivot 504 is co-linear with first and second levers 500, 502 along a longitudinal axis A-A′ which is parallel to upper and lower straight and cupped rails 540, 541, 542, 543 and bisects lever pivot 504. In this step, lancet 218 of integrated medical device 200 is extended out of dispensing and lancing mechanism 100 and positioned in a piercing position to penetrate a dermal tissue target site (not shown) of a user. In this position, connector 534 is positioned in a piercing location. The depth to which the dermal tissue target site is penetrated is set by movement of first pivot 516 toward proximal end 114 of dispensing and lancing mechanism 100. The distance (not shown) that first pivot 516 can move is preferably between about 1 mm and about 4 mm to accommodate varying depths needed to penetrate different users' dermal tissue.

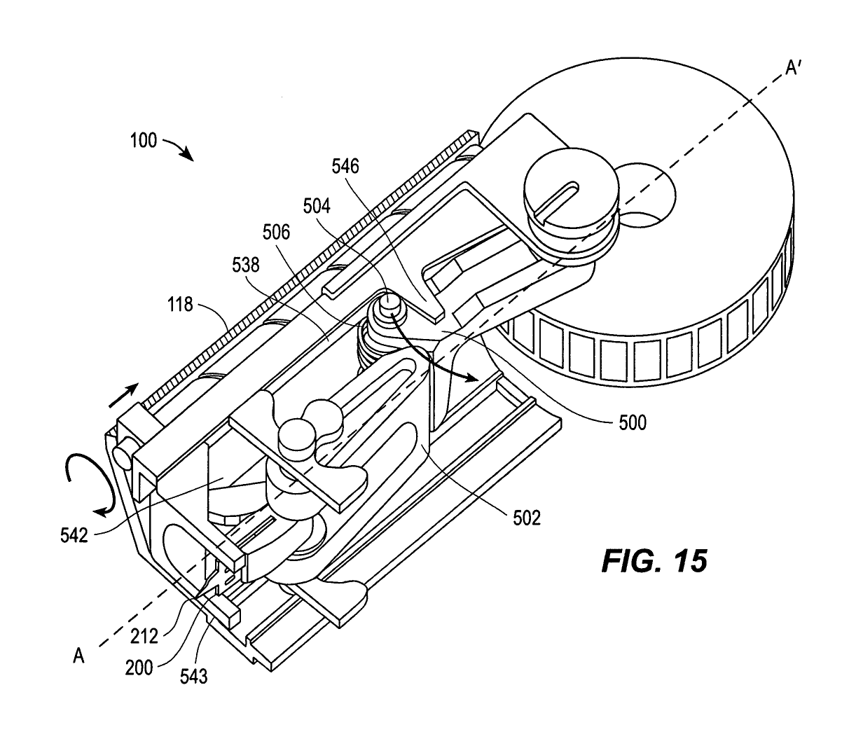

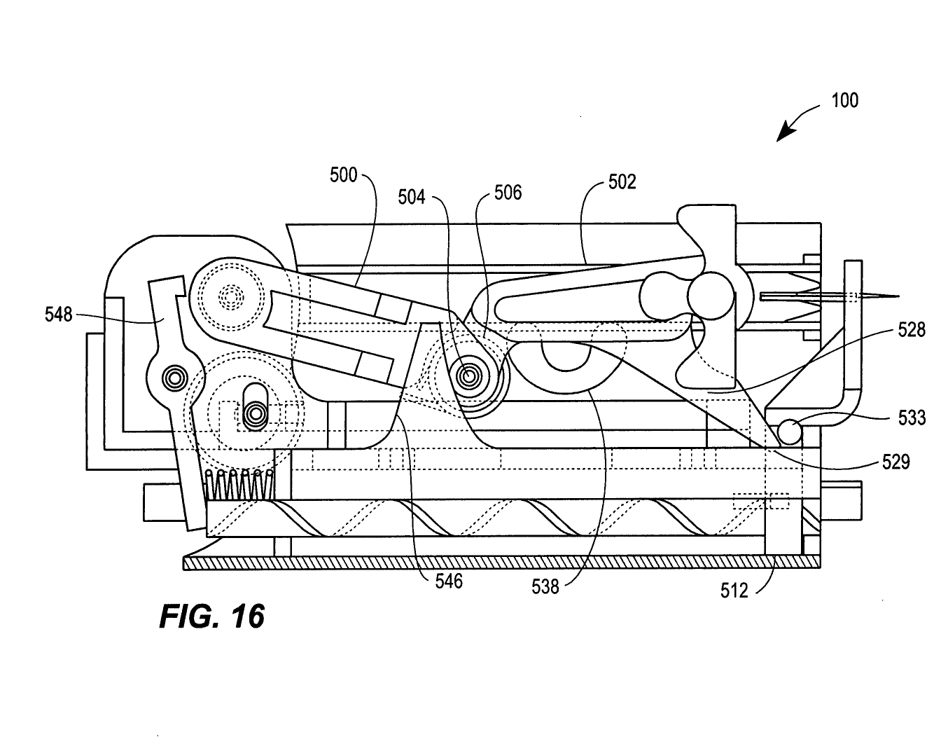

Integrated medical device 200 is then retracted from within the dermal tissue target site to the surface of the dermal tissue target site as set forth by step 850 and as illustrated in FIGS. 15 and 16. Torsion created in spring 506 forces lever pivot 504 to move laterally past upper and lower cupped rails 542, 543 toward second longitudinal side 118 of dispensing and lancing mechanism 100. Moving lever pivot 504 from a co-linear position (or at a point of maximal extension) with first and second levers 500, 502 to a position which is no longer co-linear with first and second levers 500, 502 (or past the point of maximal extension) results in first and second levers 500, 502 moving “over center” or over longitudinal axis A-A′ closer to second longitudinal side 118. The “over center” movement causes movement of connector 534 toward cartridge 300 by about 0.5 mm to about 3.5 mm for the exemplary dispensing and lancing mechanism 100, so connector 534 is positioned in a fluid extraction or sampling location. Positioning connector 534 at this fluid extraction location causes retraction of integrated medical device 200 from within the dermal tissue target site to a fluid extraction or sampling position at or just below the surface of the dermal tissue target site (see FIG. 15). The “over center” movement is facilitated by tension created in spring 506 while first and second levers 500, 502 are co-linear with lever pivot 504. In the fluid extraction position, dermal tissue penetration member 212 is able to, by capillary action, absorb blood pooling at or just below the surface of the wound site. The fluid extraction position is determined by the placement of lever pivot 504 against positioner 546 (see FIG. 16). The location and form of positioner 546 is such that the fluid extraction position of integrated medical device 200 will not vary, even if the depth to which the dermal tissue is penetrated does vary. Metering system 400 can now measure an analyte in the sample and can then be removed from the dermal tissue site.

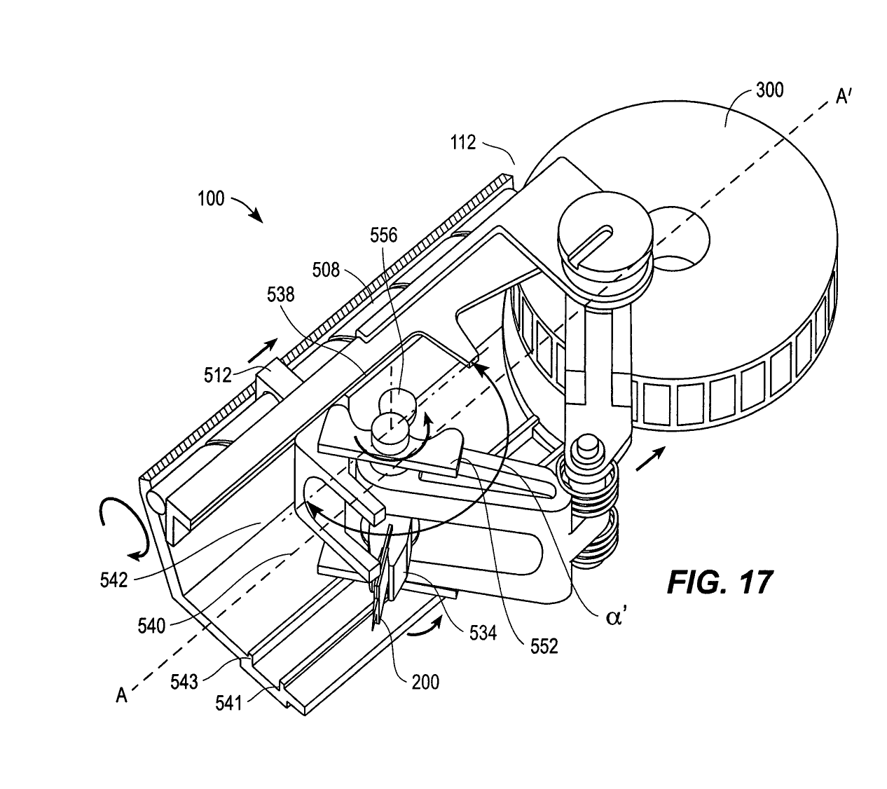

Next, integrated medical device 200 is retracted from an “over center” position to within dispensing and lancing mechanism 100, as set forth by step 860 and as illustrated in FIG. 17. Motor 310 rotates lead screw 508 such that sliding carriage 512 moves toward cartridge 300. Movement of sliding carriage 512 initiates contact of proximal end 529 of extension 528 on second lever 502 with extension contacting feature 533 (see FIG. 16) which urges lever pivot 504 toward second longitudinal side 118 of dispensing and lancing mechanism 100. Sliding carriage 512 moves toward distal end 112 of dispensing and lancing mechanism 100 as integrated medical device 200 is rotated through an angle α preferably ranging from about 0 degrees to about minus 180 degrees relative to longitudinal axis A-A′. Upper and lower rear lobe 556, 557 are inserted into upper and lower cups 538, 539 and upper and lower first lateral lobes 551, 552 are urged laterally toward upper and lower straight rails 540, 541 as integrated medical device 200 is rotated counterclockwise, as illustrated in FIG. 17.

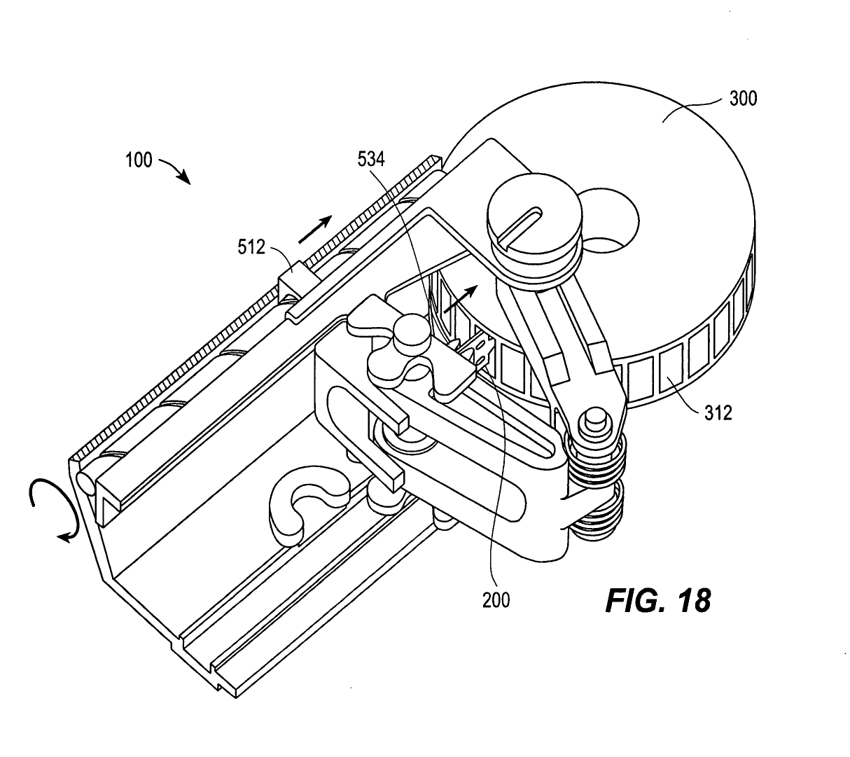

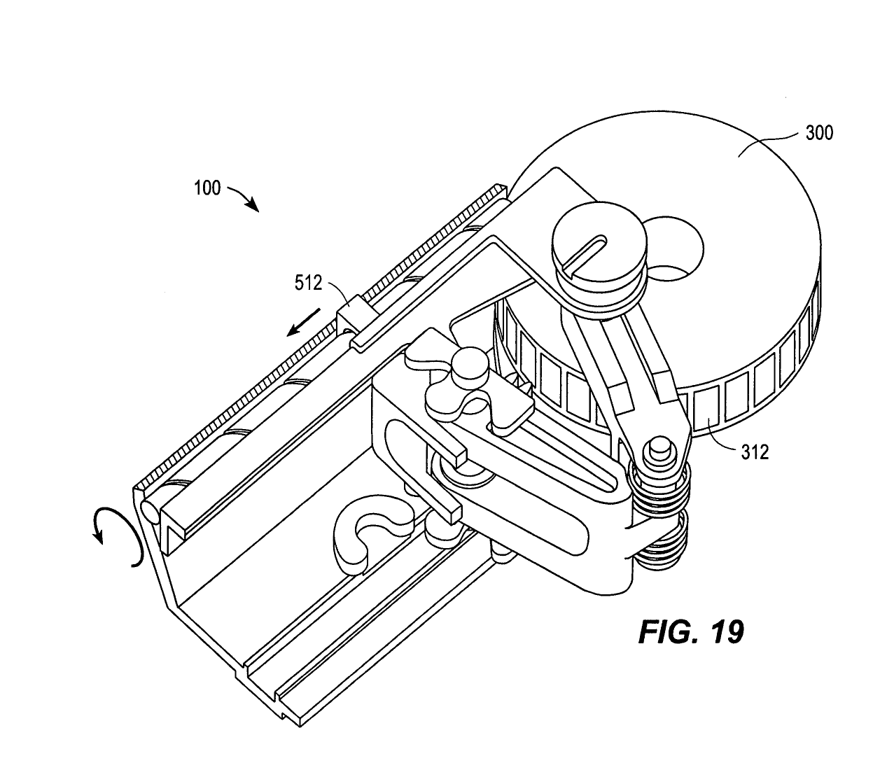

Integrated medical device 200 is returned to empty chamber 312 of cartridge 300, as set forth by step 870 and as illustrated by FIGS. 18 and 19. Used integrated medical device 200 is inserted into empty chamber 312 of cartridge 300 as illustrated by FIG. 18. Used integrated medical device 200 is retained in chamber 312 by internal features as described in U.S. patent application Ser. No. 10/666,154 to Windus-Smith et al., filed on Sep. 19, 2003, entitled “Medical Device Package, Kit and Associated Methods,” and published as US 2005-0061700 on Mar. 24, 2005, which is fully incorporated herein by reference for all purposes. Sliding carriage 512 and connector 534 moves to the rest position as cartridge 300 is indexed to the next chamber 312 by motor 510 (not shown) as illustrated in FIG. 19. As described previously, motor 510 also rotates the lead screw clockwise and counterclockwise. Thus, motor 510 beneficially performs two functions in that it controls the motion of carriage 512 and it indexes cartridge 300 to the next unused integrated medical device 200, thereby eliminating the need for two separate mechanisms and conserving space. Indexing mechanisms are described in U.S. patent application Ser. No. 11,241,418 to Newman et al., filed on Sep. 30, 2005, entitled “Cassette Assemblies for Testing Devices and Methods,” and having Atty. Docket No. LSI0145/US/2, which is fully incorporated herein by reference for all purposes.

When dispensing and lancing mechanism 710 is used in process 800, process 800 includes first providing a dispensing and lancing mechanism and a cartridge 300 containing a plurality of integrated medical devices 300 as described above in FIG. 7 and as set forth by step 810. The provision of an exemplary dispensing and lancing mechanism 710 is depicted in FIG. 7 wherein like elements of the dispensing and lancing mechanism 710 of earlier figures are identified with like numerals. The provided dispensing and lancing mechanism 710 includes an apparatus for extracting, rotating and delivering an integrated medical device 200 to a sample delivery port 758 of a metering system 700, as previously described. During this process, integrated medical device 200 is rotated in at least one plane while being delivered to sample delivery port 758. The provided dispensing and lancing mechanism 710 includes a motor (not shown), a first lever 714, a second lever 716, a lever pivot 718, a lever pivot spring (not shown), a rotatable cam 720, a slot 722 within a lever holder 724, a first track 726, a second track 728, an upper grooved surface 730, a lower grooved surface 732, and a connector 734.

Next, a connector 734 breaches (i.e. ruptures) a foil seal (not shown) and engages an unused integrated medical device 200 retained within a chamber 312 of cartridge 300, as set forth by step 820 and as shown in FIG. 20. Connector 734 engages with integrated medical device 200 with a force preferably ranging from about 3 N to 5 N, and more preferably about 4 N.

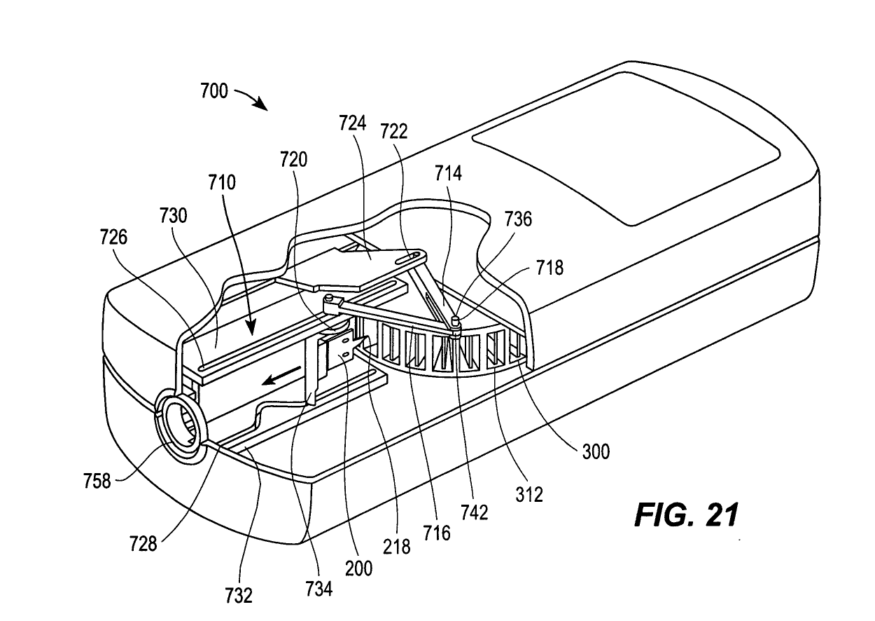

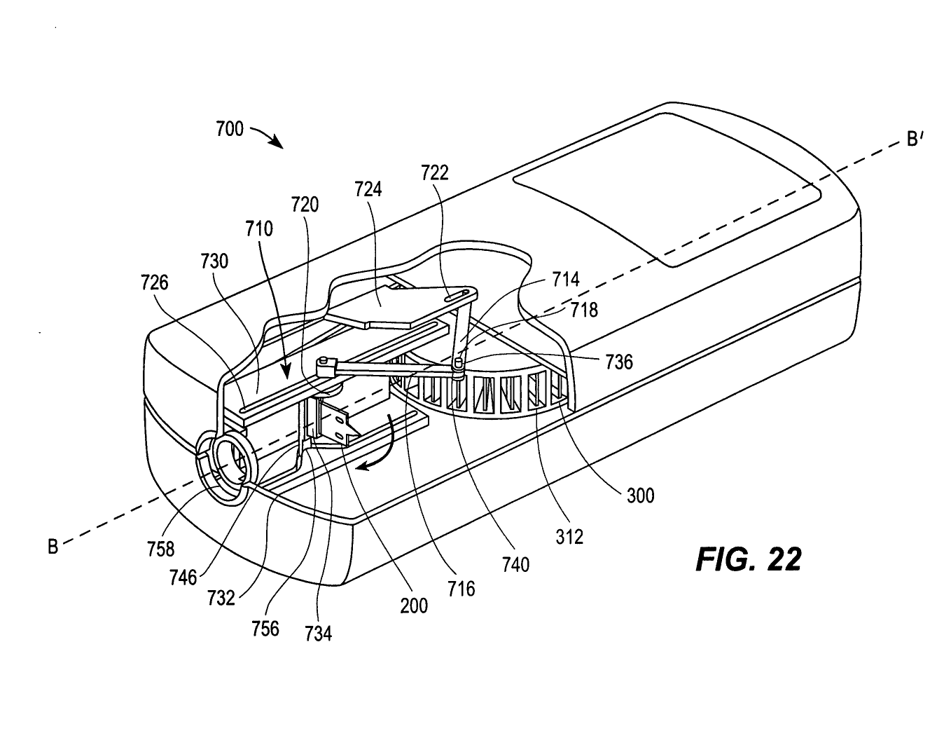

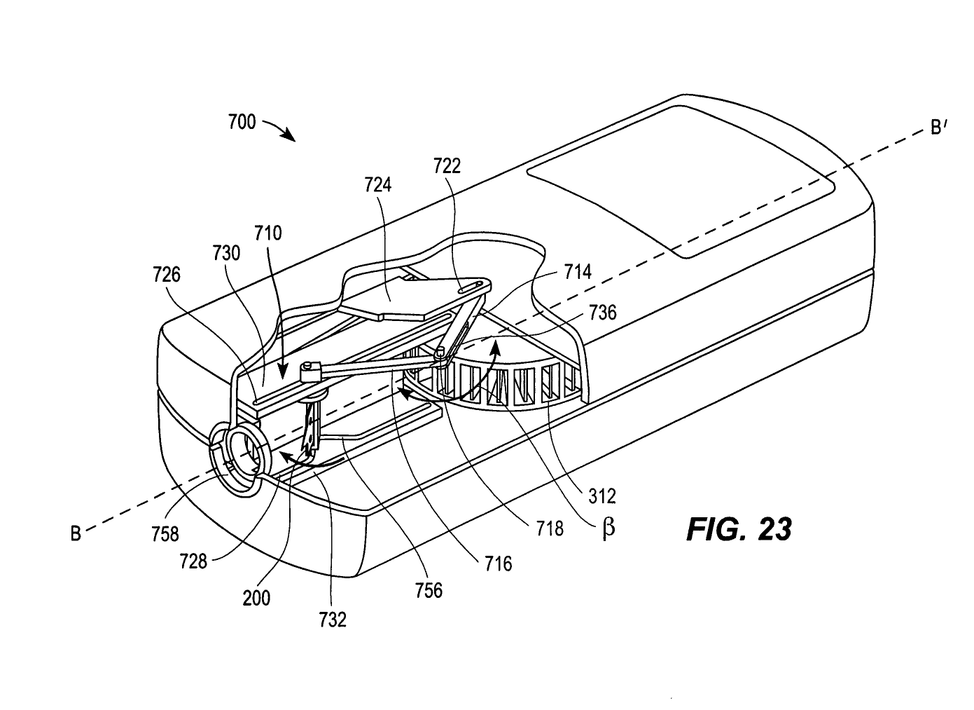

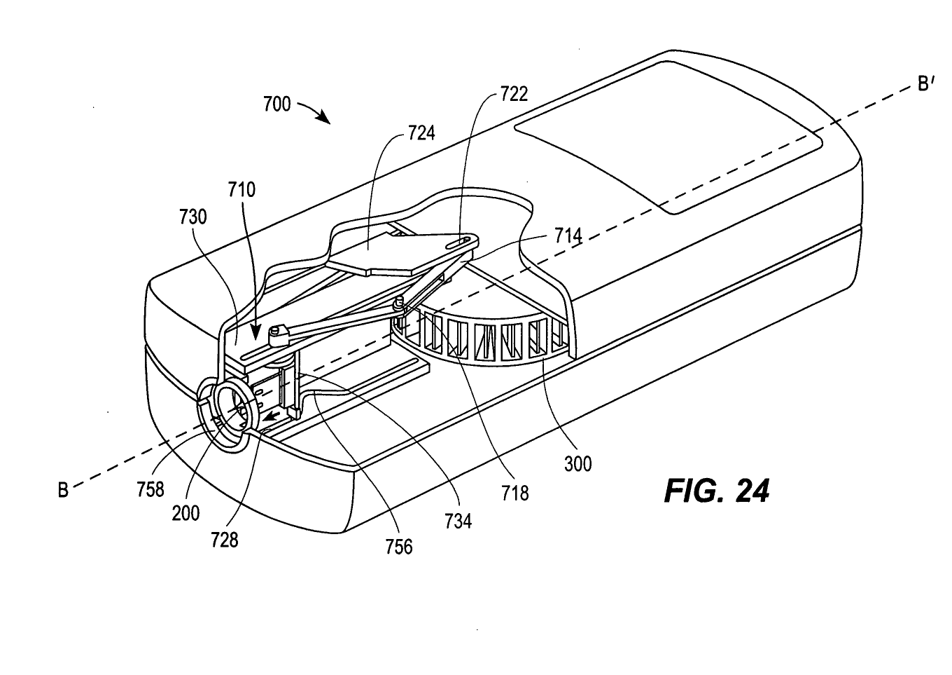

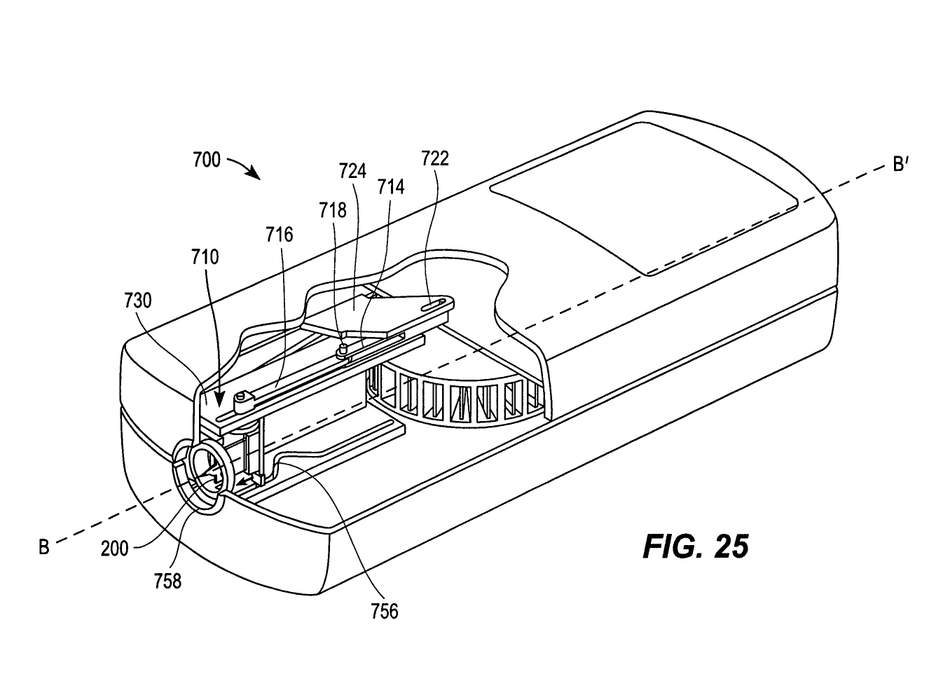

Connector 734 and engaged medical device 200 are then extracted from chamber 312 and are rotated within dispensing and lancing mechanism 100, as set forth by step 830 and as illustrated in FIG. 21-25. To extract an integrated medical device 200 from chamber 312, a moving mechanism (e.g. a motor (not shown)) moves connector 734 linearly toward sample delivery port 758. The integrated medical device 200 at this step is oriented with the lancet 218 of dermal tissue penetration member 212 directed towards cartridge 300 (see FIG. 21). Moveable end 736 of first lever 714 and second end 742 of second lever 718 move closer to first track 726 on upper grooved surface 730. A user places a dermal tissue target site in contact with sample delivery port 758 of metering system 700. Dermal tissue penetration can be triggered manually by, for example, depressing a button (not shown) on metering system 700. In this step, the motor (not shown) rotates connector 734 to a position where the lancet 218 of the dermal tissue penetration member 212 of the integrated medical device 200 is directed towards the sample delivery port 758 of metering system 700. Torsion created by the lever pivot spring (not shown) causes movement of first and second levers 714, 716 toward sample delivery port 758 of metering system 700. Connector 734 in turn moves toward sample delivery port 758 as illustrated by FIG. 22. Lower end 746 of connector 734 contacts indent 756 which forces connector 734 and engaged integrated medical device 200 to rotate through an angle β preferably ranging from about 0 degrees to about 180 degrees relative to longitudinal axis B-B′ (see FIG. 23). First and second levers 714, 716 approach a position in which first and second levers 714, 716 are co-linear (or at a point of maximal extension), as illustrated by FIGS. 24 and 25.

Next, a dermal tissue target site on a user is punctured with the integrated medical device 200 as set forth by step 740 and as illustrated in FIG. 25. When first and second levers 714, 716 are co-linear with lever pivot 718, dispensing and lancing mechanism 710 is in a test position with lancet 218 of integrated medical device 200 maximally extended out of sample delivery port 758 to penetrate a dermal tissue target site on a user. First and second levers 714, 716 are in a maximally extended position when lever pivot is co-linear with first and second levers 714, 716 along a longitudinal axis B-B′ which is parallel to upper grooved surface 730 and bisects lever pivot 718. The depth to which the dermal tissue target site is penetrated by dermal tissue penetration member 212 is set by first lever 714 within slot 722 of lever holder 724.

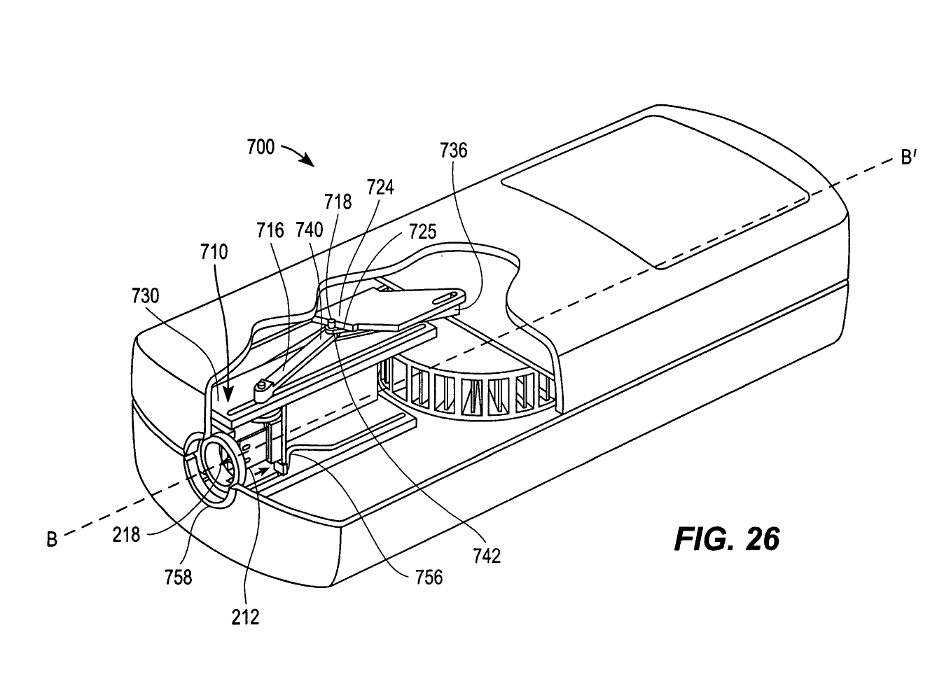

Next, integrated medical device 200 is retracted from the dermal tissue target site yet preferably remains at or just below the surface of the dermal tissue target site as set forth by step 850 and as illustrated in FIG. 26. In this step, moving lever pivot 718 from a co-linear position (or a point of maximal extension) to a position which is no longer co-linear with first and second levers 714, 716 (or past the point of maximal extension) results in first and second levers 714, 718 moving “over center” or over longitudinal axis B-B′. The “over center” movement causes retraction of integrated medical device 200 from within the dermal tissue target site to a “fluid extraction” position at or just below the surface of the dermal tissue target site. The “fluid extraction” position is determined by the placement of lever pivot 718 against a cam surface 725 on lever holder 724. In this position, integrated medical device 200 is retracted such that lancet 218 of dermal tissue penetration member 212 is in a “fluid extraction” position at or just below the surface of the dermal tissue target site. In the “fluid extraction” position, dermal tissue penetration member 212 is able to, by capillary action, absorb blood pooling at or just below the surface of the wound site. The location and form of cam surface 725 is such that the “fluid extraction” position of integrated medical device 200 will not vary, even if the depth to which the dermal tissue is penetrated does vary. Metering system 700 can now measure an analyte in the sample and can be removed from dermal tissue target site.

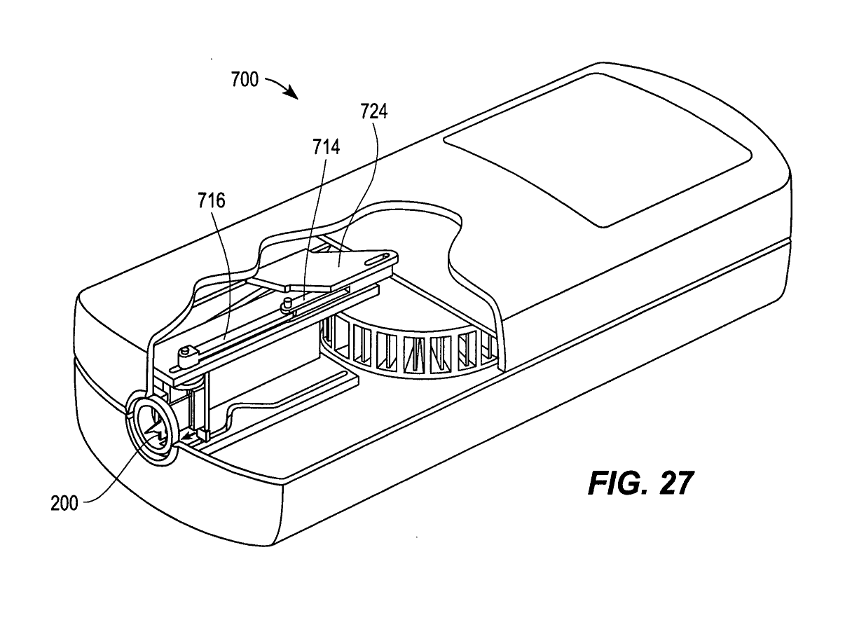

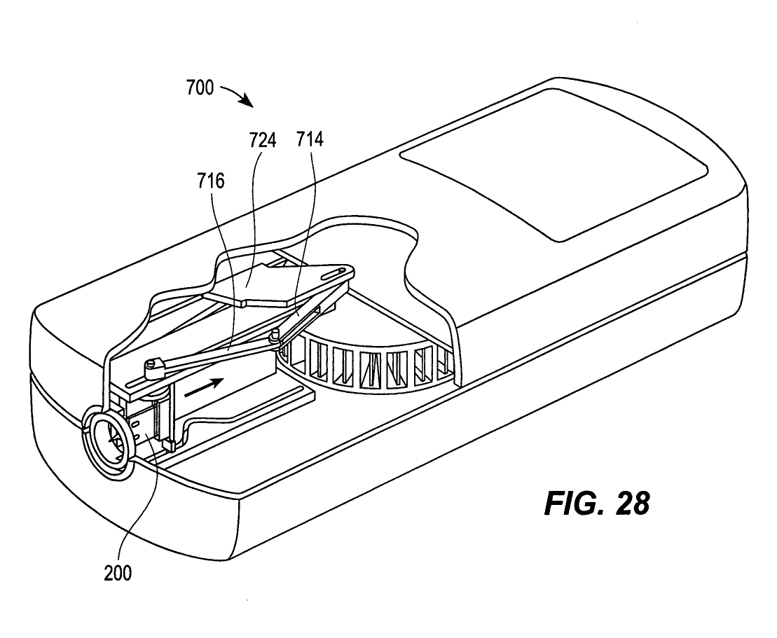

Next, integrated medical device 200 is retracted from an “over center” position to within dispensing and lancing mechanism 710, as set forth by step 860 and as illustrated in FIGS. 27 and 28. Integrated medical device 200 is first returned to the test position and first and second levers 714, 716 are returned to a position that is co-linear with lever holder 724 as illustrated in FIG. 27. Integrated medical device 200 is then retracted into metering system 700, as illustrated in FIG. 28.

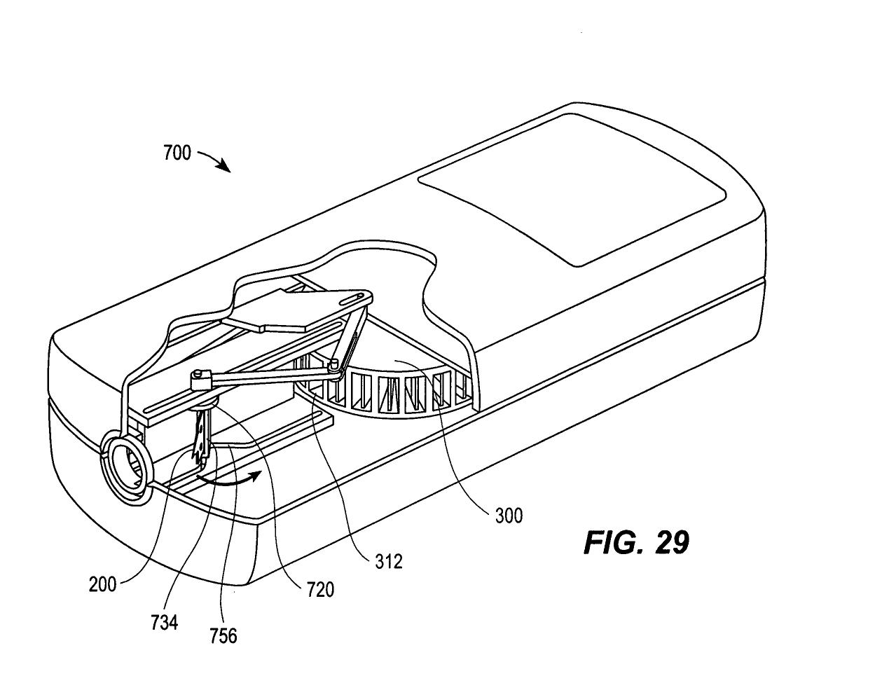

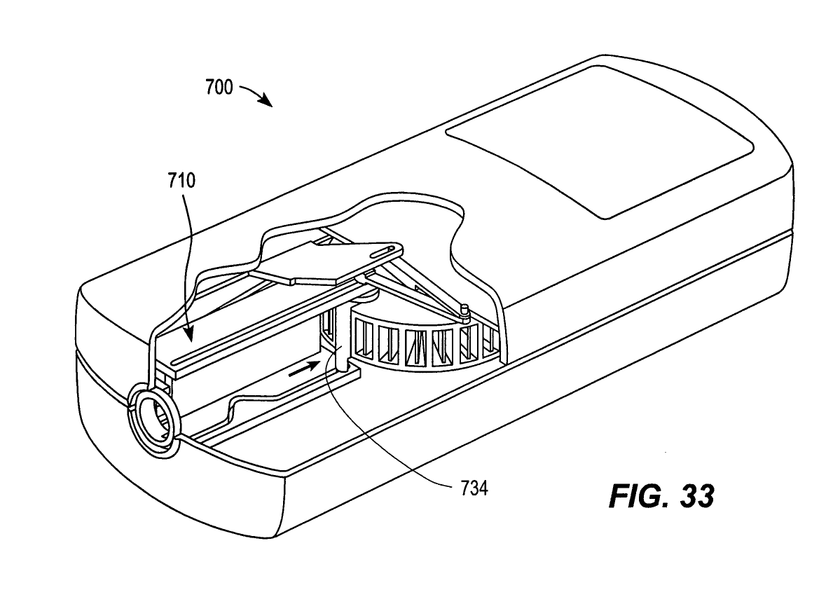

Used integrated medical device 200 is returned to a chamber 312 within the cartridge 300 as set forth by step 870 and as illustrated in FIGS. 29-33. Connector 734 is urged into indent 756, as illustrated in FIG. 29. Integrated medical device 200 is rotated about minus 180 degrees as illustrated in FIGS. 29-32. Finally, integrated medical device 200 is returned to chamber 312 of cartridge 300 as illustrated in FIG. 33.

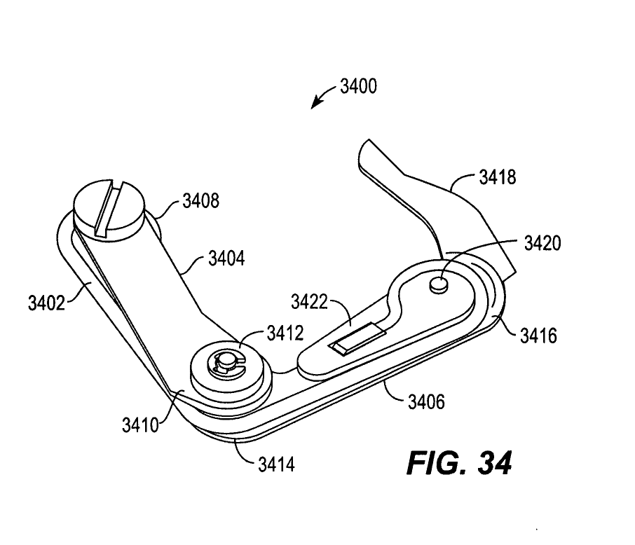

FIG. 34 is a simplified bottom view of a portion of a dispensing and lancing mechanism 3400 in accordance with the present invention. Dispensing and lancing mechanism 3400 is similar in structure and function to dispensing and lancing mechanism 100 with the exception of an elastic cord 3402 replacing spring 506 to provide sufficient tension for launching lancet 218. Dispensing and lancing mechanism 3400 includes a first lever 3404, a second level 3406, a fixed end 3408 of first lever 3404, a moveable end 3410 of first lever 3404, a lever pivot 3412, a first end 3414 of second lever 3406, a second end 3416 of second lever 3406, an extension 3418 of second lever 3406, and a second lever pivot 3420. Elastic cord 3402 encircles fixed end 3408 of first lever 3404 and extends the length of first lever 3404. Elastic cord 3402 further extends around lever pivot 3412, the length of second lever 3406 and around second lever pivot 3420 to fasten to a bottom surface 3422 of second lever 3406. Elastic cord 3402 may be made of any suitable material including natural or synthetic rubber, which allows for torsion to be generated by movement of first and second levers 3404, 3406.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A transport apparatus for use in a metering system, the transport apparatus comprising:
a frame;
a first arm pivotably connected to the frame at a first pivot point;
a second arm pivotably connected to an end of the first arm at a second pivot point;
a connecter for carrying test sensor between a first location where the connector has a first orientation and a second location where the connector has a second orientation, the connector pivotably connected to an end of the second arm at a third pivot point;
a first guiding system for guiding the third pivot point along a linear path, the first guiding system comprising a linear guide surface operatively integrated with the frame and a guide surface positioned at the end of the second arm; and
a second guiding system for changing the orientation of the connector between the first orientation and the second orientation as the third pivot point moves along the linear axis, the second guiding system comprising a first cam surface operatively integrated with the frame and a second cam surface operatively integrated with the connector.

2. The apparatus of claim 1, comprising a torsion spring at the second pivot point biased to urge the connector in a sampling direction along the linear axis.

3. The apparatus of claim 2, comprising a linearly drivable carriage that can engage with the second arm and drive the connector in a direction opposite the sampling direction along the linear axis.

4. The apparatus of claim 3, comprising a releasable locking mechanism to hold the connector against the bias of the torsion spring in a loaded configuration.

5. The apparatus of claim 1, wherein the second guiding system changes the orientation of the connector by rotating the connector about the third pivot point by about 180 degrees.

6. The apparatus of claim 1, wherein the guide surface positioned at the end of the arm comprises a guide surface of the connector.

7. The apparatus of claim 1 in combination with a metering system.

8. The combination of claim 7, wherein the metering system comprises a source of test sensors.

9. The combination of claim 8, wherein the first location comprises a storage location of an individual test sensor of the source of test sensors.

10. The combination of claim 9, wherein the second location comprises a sampling location for a test sensor of the metering system.

11. A transport apparatus for use in a metering system, the transport apparatus comprising:
a frame;
a first arm pivotably connected to the frame at a first pivot point;
a second arm pivotably connected to an end of the first arm at a second pivot point;
a connecter for carrying a test sensor between a first location where the connector has a first orientation and a second location where the connector has a second orientation, the connector pivotably connected to an end of the second arm at a third pivot point;
a first guiding system that guides the end of the second arm so the third pivot point travels along a linear axis upon rotation of the first arm about the first pivot point; and
a second guiding system that changes the orientation of the connector between the first orientation and the second orientation as the connector moves along the linear axis.

12. The apparatus of claim 11, wherein the first guiding system comprises a linear guide surface operatively integrated with the frame and a guide surface positioned at the end of the second arm.

13. The apparatus of claim 11, wherein the second guiding system comprises a first cam surface operatively integrated with the frame and a second cam surface operatively integrated with the connector.

14. A method for moving a connector between a first location where the connector has a first orientation and a second location where the connector has a second orientation in a metering system, the method comprising the steps of:
providing a transport apparatus comprising a frame, a first arm pivotably connected to the frame at a first pivot point, a second arm pivotably connected to an end of the first arm at a second pivot point, and a connecter pivotably connected to an end of the second arm at a third pivot point;
causing the first arm to rotate about the first pivot point and the second arm to rotate about the second pivot point;
translating the third pivot point along a linear path; and
rotating the connector about the third pivot point between a first orientation and a second orientation while the third pivot point is translated along the linear path.

15. The method of claim 14, comprising providing a torsional force at the second pivot point that rotates the first and second arms relative to each other.

16. The method of claim 15, comprising rotating the first and second arms relative to each other in a first rotational direction to position the connector at a piercing position.

17. The method of claim 16, comprising further rotating the first and second arms relative to each other in the first rotational direction to position the connector at a sampling position spaced apart from the piercing position.

18. The method of claim 14, comprising guiding the end of the second arm while translating the third pivot point along the linear path.

19. The method of claim 18, comprising engaging a first cam surface operatively integrated with the connector with a second cam surface operatively integrated with the frame to rotate the connector about the third pivot point.

20. The method of claim 14, comprising providing a source of test sensors relative to the transport apparatus.
